(19) United States
(12) Patent Application Publication
(10) Pub. No.: US 2021/0331666 A1
(43) Pub. Date: Oct. 28, 2021

(54) ENVIRONMENT ACTIVE SENSING-TYPE AUTOMATIC PARKING SYSTEM IN PARKING LOT

(71) Applicant: ZHEJIANG UNIVERSITY, Hangzhou City (CN)

(72) Inventors: Jun MENG, Hangzhou City (CN); Shaoshuai WANG, Hangzhou City (CN)

(21) Appl. No.: 17/368,802

(22) Filed: Jul. 6, 2021

Related U.S. Application Data
(63) Continuation of application No. PCT/CN2020/093825, filed on Jun. 2, 2020.

(30) Foreign Application Priority Data
Jun. 24, 2019 (CN) 201910549396.8

(51) Int. Cl. B60W 30/06; G08G 1/14; G06K 9/00; H04N 5/247; G06K 7/14; G06K 7/10

(52) U.S. Cl. CPC B60W 30/06; G08G 1/14; G06K 9/00785; H04N 5/247; B60W 2540/18; G06K 7/10722; B60W 2420/42; B60W 2540/10; B60W 2540/12; G06K 7/1417

(57) ABSTRACT

Disclosed is an environment active sensing-type automatic parking system in a parking lot, including a vehicle information acquisition and identification module, a multi-sensor positioning module, a building information model module, a classification processing module, path planning and navigation module, a parking space state judgment module, a two-flywheel steering device and a mechanical power device. A QR code, a mechanical power device, and a two-flywheel steering device are mounted onto a vehicle, the QR code is identified by using a camera in the parking lot to achieve continuous positioning, an optimal path is planned according to vehicle distribution information in the current parking lot, and the driving speed and driving direction of the vehicle are controlled by remotely controlling the mechanical power device in the vehicle, so as to achieve automatic parking in the parking lot.

### TECHNICAL FIELD

The present disclosure relates to the field of driverless vehicle technologies, and in particular, to an environment active sensing-type automatic parking system in a parking lot.

### BACKGROUND

With the continuous development of economy and the continuous growth of the number of cars, the construction of parking lots is also increasingly expanding. Existing parting lots have a complicated internal structure, and some parking lots even have a layered structure, which makes it difficult for users to find their cars frequently. Due to the lack of traffic dispersion, when the volume of traffic in a parking lot is high, roads inside the parking lot are often blocked or even paralyzed. These problems bring great inconvenience to the users when they park and pick up their cars.

An automatic driving technology is the core of the future intelligent transportation technology. Although a driverless vehicle technology is adopted in a parking lot to solve the above problems of difficult parking and difficult pickup, the high cost of current driverless vehicles and related sensors on the market is out of reach for ordinary users. As a result, the popularity of driverless vehicles remains low. Moreover, an underground parking lot is in a poor environment, and the precision of lidar and other sensors on the driverless vehicles will be greatly reduced. It may occur that the vehicles cannot sense the environment of the parking lot, and even accidents such as scratch and collision may occur.

Therefore, a new automatic parking system in a parking lot is urgently needed, so that users can park and pick up their cars quickly and accurately without paying high fees.

### SUMMARY

An objective of the present disclosure is to provide an environment active sensing-type automatic parking system in a parking lot with respect to the deficiency in the related art, to transform a traditional mode in which vehicles sense environments through their own sensors is transformed into a mode in which the environments actively sense vehicle positions through an array sensor. A large number of cheap sensors in the environments may achieve precise positioning of the vehicles through a multi-sensor fusion technology, which solves the problem of relatively high costs and low precision of driverless vehicle sensors.

The objective of the present disclosure is implemented through the following technical solutions: an environment active sensing-type automatic parking system in a parking lot, wherein the system includes a vehicle information acquisition and identification module, a multi-sensor positioning module, a building information model module, a classification processing module, a path planning and navigation module, a parking space state judgment module, a two-flywheel steering device, and a mechanical power device;
the vehicle information acquisition and identification module includes a number of cameras mounted in the parking lot and QR codes mounted onto roves of the vehicles; and the information acquisition and identification module acquires vehicle information, and a unique ID is assigned to each of the vehicles;
the multi-sensor positioning module receives the vehicle information acquired by the vehicle information acquisition and identification module, and positions the vehicles;
the building information model module is configured to establish a space model for building information of the parking lot, generate a GIS electronic map, and mark parking spaces and the vehicle positions in the parking lot in the electronic map;
the parking space state judgment module is configured to judge whether there are vehicles in the parking spaces to obtain parking space state information;
the path planning and navigation module is configured to plan an optimal path according to vehicle distribution and the parking space state information in the lot, so as to navigate vehicles into the parking spaces;
the two-flywheel steering device is mounted at a maximum diameter of a steering wheel, a two-flywheel device includes a gyro sensor, the moment of inertia of two flywheels and a speed difference between the two flywheels enable the steering wheel to rotate in a designated direction and at a designated angle, and a deflection angle of the steering wheel is calculated according to a height difference between the two flywheels, an angle between a plane where the steering wheel is located and a horizontal plane, and a diameter of the steering wheel;
the mechanical power device includes a first motor and a second motor, the first motor is configured to control lifting up or pressing down an accelerator pedal, and the second motor is configured to control lifting up or pressing down a brake pedal;
the classification processing module classifies the acquired vehicle information into three categories, which are a manual driving vehicle, a semi-autonomous driving vehicle, and a full-autonomous driving vehicle respectively;
the manual driving vehicle includes a QR code mounted onto the roof of the vehicle, a mechanical power device and a two-flywheel steering device, and automatic parking of the manual driving vehicle is achieved by turning the steering wheel through the moment of inertia of the two flywheels and coordinated control of the two flywheels;
the semi-autonomous driving vehicle includes an autonomous driving power device and a control device, and a QR code mounted onto the roof of the vehicle, so as to achieve communication of position information and environmental information between the parking lot and the vehicle, and an automatic parking function is implemented by using a semi-autonomous driving apparatus of the vehicle; and
the full-autonomous driving vehicle includes complete power and control devices, and a sensor capable of identifying an environment, the parking lot establishes communication with the full-autonomous driving vehicle, and an automatic parking function is achieved by sending path planning, parking space state information, and vehicle distribution information to the vehicle.

Further, the vehicle information acquired by the vehicle information acquisition and identification module includes: vehicle entry time, license plate number, and other information, a unique ID is assigned to each of the vehicles according to the license plate number, and the cameras in the vehicle information acquisition and identification module are capable of acquiring and identifying information of the vehicle in every corner of the parking lot without dead angles.

Further, in the vehicle information acquisition and identification module, a polarized light receiver is further mounted around the vehicle to replace the QR code on the roof of the vehicle.

Further, the environment active sensing-type automatic parking system in a parking lot further includes WIFi, Bluetooth, and ZigBee communication devices for auxiliary positioning.

Further, the multi-sensor positioning module is a binocular camera, and calculation formulas of a real coordinate value of a vehicle position are as follows:

$$d = \vert xl - xr \vert$$

$$x = \frac{B \cdot xl}{d}$$

$$y = \frac{B \cdot yt}{d} \\ z = \frac{f \cdot B}{d}$$

wherein f is a camera focal length, coordinates of left and right cameras are (xl, yl) and (xr, yr) respectively, the two cameras have the same height, and thus yl=yr=yt, B is a baseline distance between the two cameras, and d is an absolute value of an x-axis difference between the left and right cameras.

Further, the multi-sensor positioning module is a multi-view camera, the QR code on the vehicle is captured by multiple cameras, and a real coordinate value of the vehicle is obtained by making adjustment calculation by using a multi-sensor fusion method.

Further, the path planning and navigation module calculates vehicle density on each route, and then calculates an optimal path of a to-be-parked vehicle in combination with a breadth first algorithm; generates a corresponding control algorithm according to optimal path information of each vehicle, and then sends a control instruction to the two-flywheel steering device and the mechanical power device in the vehicle through remote communication to navigate the vehicle.

Further, the system further includes a feedback self-correction module, which is configured to position a vehicle by identifying the QR code on the roof of the vehicle when the vehicle deviates from an originally planned path, calculate an error between the position and a correct position, and then correct the position and attitude of the vehicle through a PID feedback control algorithm.

Further, the mechanical power device is configured to control movement and stop of the vehicle and feed back vehicle speed and direction signals to a feedback self-correction module.

Further, the gyro sensor in the two-flywheel steering device calculates a height difference h between the two flywheels, a projection of the height difference between the two flywheels onto the plane where the steering wheel is located is recorded as h′, the angle between the plane where the steering wheel is located and the horizontal plane is recorded as α, and the diameter of the steering wheel is recorded as L; then the deflection angle θ of the steering wheel is calculated based on the following calculation formulas:

$${h}^{′} = h \text{/} sin α$$

$$θ = arctan \frac{2 {h}^{′}}{L} .$$

Further, a manner in which the two-flywheel steering device and the mechanical power device control the vehicle is as follows:
when a left turn instruction is received, left and right flywheels begin to rotate faster in a counterclockwise direction, and the rotation of the two flywheels causes the steering wheel to obtain the moment of inertia for turning left; a first motor controls a connecting rod to press down the accelerator pedal, and a second motor controls a connecting rod to lift up the brake pedal, so that the vehicle body maintains a certain turning speed.

When a right turn instruction is received, the left and right flywheels begin to rotate faster in a clockwise direction, and the rotation of the two flywheels causes the steering wheel to obtain the moment of inertia for turning left; the first motor controls a connecting rod to press down the accelerator pedal, and the second motor controls a connecting rod to lift up the brake pedal, so that the vehicle body maintains a certain turning speed.

When a straight-going instruction is received, the left and right flywheels rotate at a constant speed, so that the front maintains its original posture; the first motor controls a connecting rod to press down the accelerator pedal, and the second motor controls a connecting rod to lift up the brake pedal, so that the vehicle body maintains a certain forward speed.

When a brake instruction is received, the left and right flywheels rotate at a constant speed, so that the front maintains its original posture; the second motor controls a connecting rod to press down the brake pedal, and the first motor controls a connecting rod to lift up the accelerator pedal, so that the vehicle body slows to a stop state.

The present disclosure has the following beneficial effects:

1. The present disclosure adopts a method of actively sensing vehicle information by an environment rather than the traditional method of identifying an environment by a vehicle. The use of such an environment sensing method can greatly reduce the costs of driverless vehicles. Positioning and reuse of a plurality of vehicles can be achieved only by mounting sensors in an environment without the need to mount the sensors on each vehicle.

2. The present disclosure utilizes an array sensor fusion technology to achieve underground positioning of vehicles, and improves the accuracy of positioning compared with an existing single sensor.

3. Compared with the traditional modified driverless vehicle power device, the mechanical power device of the present disclosure has the characteristics of easy mounting and easy disassembly.

### BRIEF DESCRIPTION OF DRAWINGS

FIG. 1 is a logical relation diagram according to the present disclosure;

FIG. 2 is a control logic diagram of a two-flywheel steering device and a mechanical power device;

FIG. 3 is a workflow diagram of a parking lot according to the present disclosure;

FIG. 4 is a schematic diagram of arrangement and positioning of cameras in the parking lot according to the present disclosure;

FIG. 5 is a schematic diagram of an internal structure and parking spaces of the parking lot according to the present disclosure;

FIG. 6(a) is a schematic mounting diagram of the two-flywheel steering device at a steering wheel according to the present disclosure;

FIG. 6(b) is a schematic mounting diagram of the mechanical power device according to the present disclosure;

FIG. 7 is a schematic diagram of parallel parking according to the present disclosure; and

FIG. 8 is a schematic diagram of reversing into a parking space according to the present disclosure.

### DESCRIPTION OF EMBODIMENTS

In order to make the objective, technical solutions, and advantages of the present disclosure clearer, the present disclosure is described below in further detail with reference to embodiments. Schematic embodiments of the present disclosure and descriptions thereof are only used to explain the present disclosure and are not considered as limiting the present disclosure.

Embodiment 1

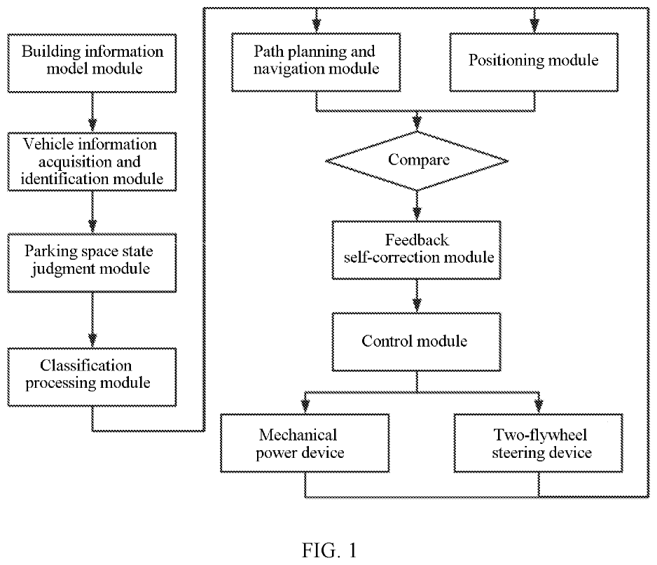

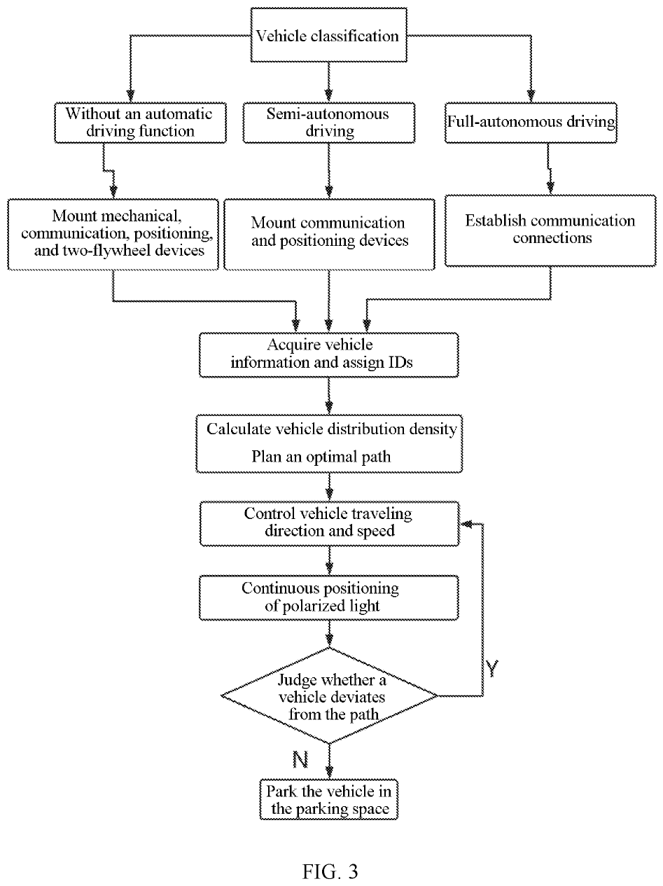

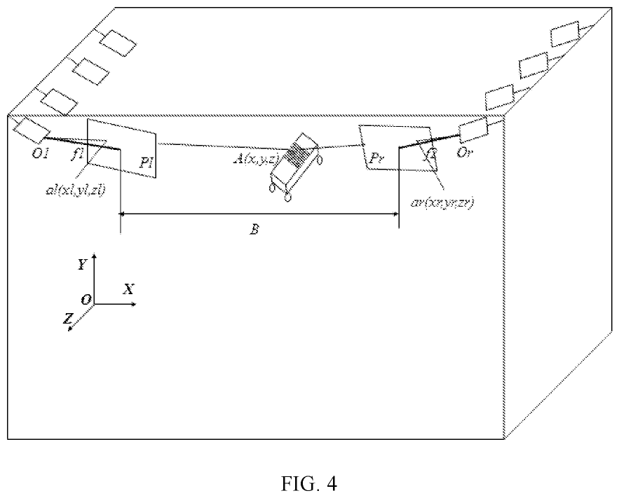

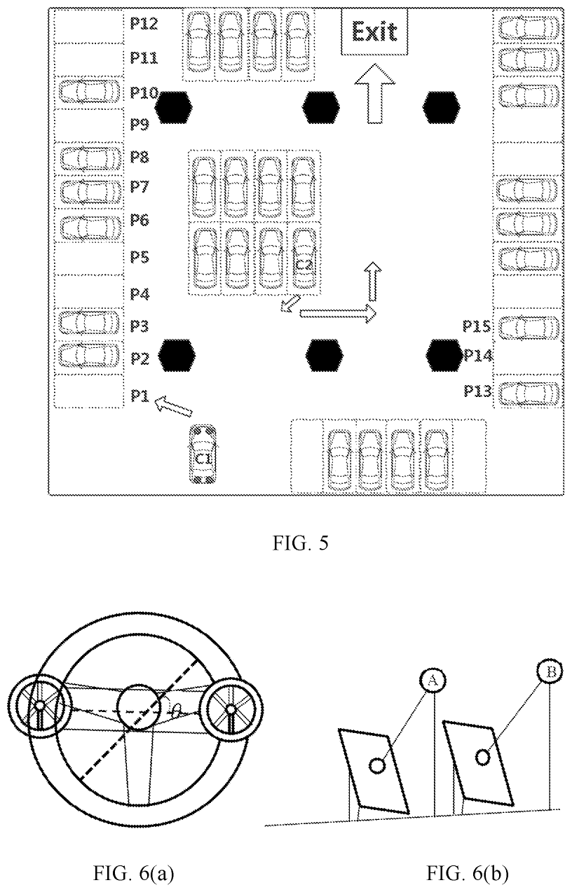

As shown in FIG. 1 to FIG. 6, a manual driving vehicle C1 is parked in a parking space P1, and the following steps are sequentially performed.

1) At an entrance: a QR code or a polarized light receiver, a communication device, a mechanical power device, and a two-flywheel steering device are mounted on the vehicle, and identity information of a to-be-parked vehicle is acquired. The identity information includes position information, license plate number information, and time information, etc. An ID is assigned to the vehicle.

2) State information of parking spaces in the parking lot is acquired. The state information includes whether there is an idle parking space.

3) It is calculated according to current parking space information and vehicle distribution information that C1 is an optimal parking space. An optimal path in this case is to turn left and enter the parking space.

4) A corresponding control scheme is calculated according to the optimal path: the two-flywheel steering device is controlled for differential rotation first, the rotation speed of the right wheel is higher than that of the left wheel to make the steering wheel turn left, a rotation angle is controlled through a PID algorithm, then an accelerator mechanical power device A is started, so that the vehicle gets power, and the force of stepping on the accelerator is controlled through the PID algorithm, so that the vehicle moves forward in accordance with a set speed.

5) During driving, two or more cameras in the parking lot capture the QR code on the vehicle body, and continuous positioning of the vehicle can be achieved through parallax correction and positioning formulas.

6) When part of the vehicle body enters the parking space and the vehicle body is parallel to the parking line, the accelerator mechanical power device A stops and a brake mechanical power device B is started to make the vehicle speed gradually decrease, the two-flywheel steering device is then controlled for differential rotation to make the rotation speed of the left wheel high than that of the right wheel, and the steering device is gradually straightened. The two processes both adopt PID feedback control to ensure the accuracy and stability of the control.

7) When the body is safely parked in the parking space, a control signal of the brake mechanical power device increases rapidly, making the vehicle stop immediately in the current position. The parking has been completed, and the state information of the parking space has changed from idle to busy.

Embodiment 2

A semi-autonomous driving vehicle C2 is picked up and driven to the EXIT, and the following steps are sequentially performed.

1) A wake-up function is implemented through a communication device according to the ID of the vehicle C2, and then the vehicle is positioned through a multi-view camera. The specific positioning method is similar to that in Embodiment 1, and the position of the vehicle can be calculated by parallax and positioning formulas. Since C2 is a semi-autonomous driving vehicle, power and control devices of the vehicle can be used.

2) According to vehicle distribution and parking space state information in the parking lot, the density of each route in the lot is calculated and displayed in a GIS map.

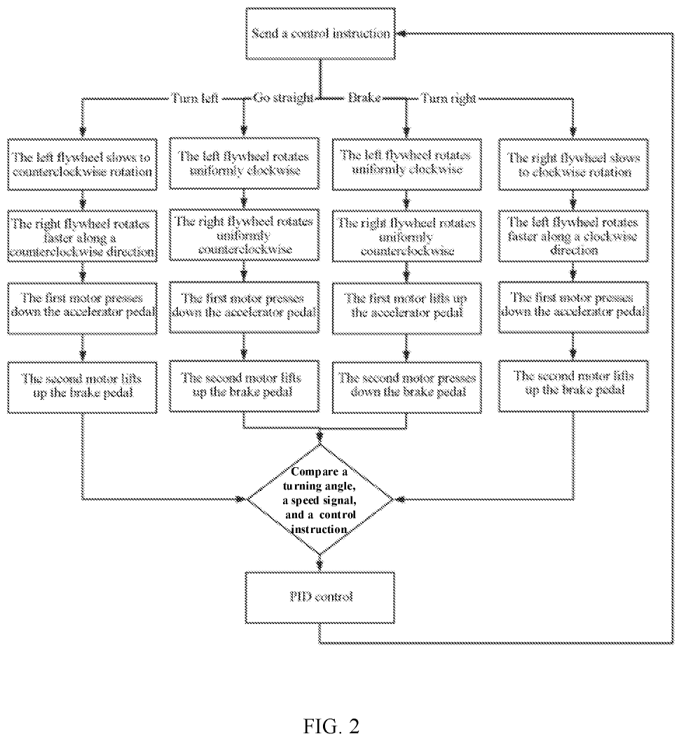

3) An optimal exit path is planned for a to-be-parked vehicle according to the above information through the path planning and navigation module. The optimal path in this case is as shown by the arrows in FIG. 2.

4) A server in the parking lot sends a signal of turning left and back. When the vehicle reaches a designated position 1, the server then sends a command of going straight ahead, when it reaches a designated position 2, the server sends a command of going straight on and turning left, when it reaches a designated position 3, the server sends a command of going straight, and when it reaches the exit, the server sends a signal of stopping.

5) In the traveling process described above, the cameras in the parking lot continuously position the current vehicle to judge whether the vehicle deviates from the planned path.

6) When the vehicle successfully arrived at the exit, an original parking space signal changes from a busy state to an idle state, map information is refreshed, the leaving time is recorded, and the vehicle is charged according to the parking time and the leaving time.

Embodiment 3

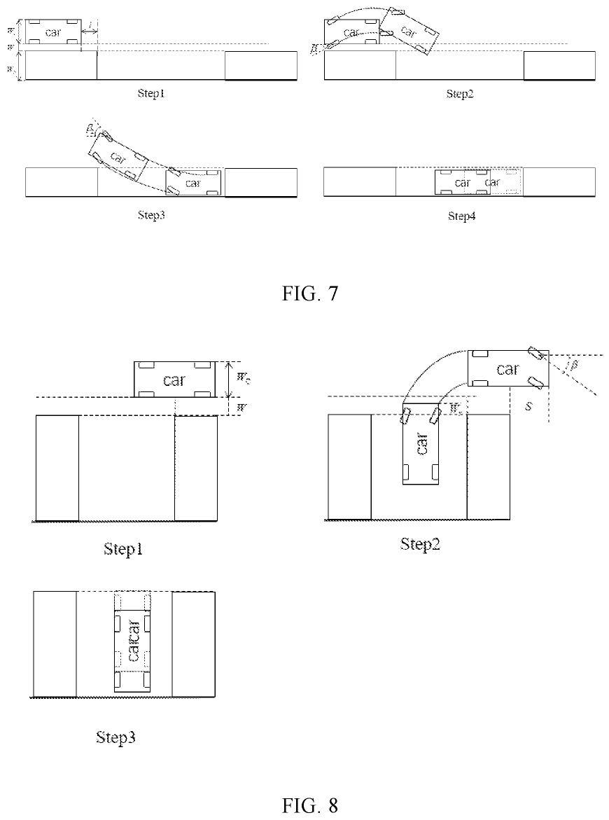

As shown in FIG. 7, when a vehicle needs to complete parallel parking (horizontal parking), the vehicle sequentially performs the following steps in the figure:

Step 1: the vehicle first drives forward by a distance r to make a horizontal distance between the rear and the parking line be l and a longitudinal distance between the vehicle and the parking space be W, the width of the vehicle is W_{C}, and the width of the parking space in the parking lot is W_{P}.

Step 2: a deflection angle of the vehicle wheel is kept to a maximum angle β₁, and the vehicle moves back by a distance S₁, in which case a rotation angle of the body around the center of the circle is θ₀.

Step 3: the steering wheel deflects in the opposite direction at an angle β₂, and |β₂|=|β₁|. The angle β₂ is kept unchanged, the rear wheel moves back by a distance S₂, a rotation angle of the body around the center of the circle is θ₁, and an absolute value of θ₁ is equal to θ₀, in which case a motion radius of the body is a minimum turning radius Rₘᵢₙ of the vehicle.

Step 4: the vehicle body has been completely parked in the parking space, and the vehicle body is parallel to the parking space, in which case the vehicle moves forward by an appropriate distance to stop in the middle of the parking space.

It is calculated according to the following formulas that a horizontal distance between the rear and the parking line is l and the rotation angle of the body around the center of the circle is θ₀:

$${θ}_{0} = {θ}_{1} \\ {θ}_{0} = arccos ( 1 - \frac{W + {W}_{P}}{2 \times {R}_{min} + {W}_{C}} ) \\ l = ( 2 \times {R}_{min} + {W}_{C} ) \times sin ( {θ}_{0} ) - \sqrt{{R}_{max}^{2} - {R}_{min}^{2}}$$

In the formulas, Rₘₐₓ is a maximum turning radius of the vehicle.

Embodiment 4

As shown in FIG. 8, when a vehicle needs to complete the operation of reversing into a parking space (longitudinal parking), the vehicle sequentially performs the following steps in the figure:

Step 1: the vehicle is kept parallel to the parking space and drives forward by a distance S, a distance from the front to the parking line is Wᵣ, which is a safe distance for the vehicle to reverse, a longitudinal distance between the vehicle and the parking space is W, and the width of the vehicle is W_{C}.

Step 2: a deflection angle of the vehicle wheel is kept to a maximum angle β₁, and the vehicle moves back by a distance S₁, in which case a rotation angle of the body around the center of the circle is θ′. When the vehicle body is parallel to the parking space, the steering wheel is straightened.

Step 3: the vehicle moves back by a distance, and the whole vehicle body is parked in the middle of the parking space.

Calculation formulas for the distance Wᵣ between the front and the parking line and the rotation angle θ′ of the vehicle body around the center of the circle are as follows:

$${θ}^{′} = arccos ( \frac{2 {R}_{min}}{2 W + {W}_{C}} )$$

$${W}_{r} = ( 2 {R}_{min} + {W}_{C} ) \times cos {θ}^{′} - ( {W}_{C} + W + {R}_{min} )$$

In the present disclosure, based on the technical concept of actively sensing vehicles by an environment, high-precision positioning of the vehicles underground can be achieved only by mounting devices such as cameras or polarization light sources, and infrared sensors in the parking lot at one time, without the need to mount expensive lidar sensors in each vehicle. A search optimization algorithm can ensure that the vehicles can be parked in the best parking space in the first time, saving the parking time and improving the operation efficiency of the parking lot.

The objective, technical solutions, and beneficial effects of the present disclosure are described in further detail through the specific implementations described above. It should be understood that the above are only specific implementations of the present disclosure and are not intended to limit the scope of protection of the present disclosure. Any modification, equivalent replacement, improvement and the like made within the spirit and principle of the present disclosure should all be encompassed in the scope of protection of the present disclosure.

What is claimed is:

1. An environment active sensing-type automatic parking system in a parking lot, wherein the system comprises a vehicle information acquisition and identification module, a multi-sensor positioning module, a building information model module, a classification processing module, a path planning and navigation module, a parking space state judgment module, a two-flywheel steering device, and a mechanical power device;
the vehicle information acquisition and identification module comprises a number of cameras mounted in the parking lot and QR codes mounted onto rooves of vehicles; and the vehicle information acquisition and identification module acquires vehicle information, and a unique ID is assigned to each of the vehicles;
the multi-sensor positioning module receives the vehicle information acquired by the vehicle information acquisition and identification module, and positions the vehicles;
the building information model module is configured to establish a space model for building information of the parking lot, generate a GIS electronic map, and mark parking spaces and vehicle positions in the parking lot in the electronic map;
the parking space state judgment module is configured to judge whether there are vehicles in the parking spaces to obtain parking space state information;
the path planning and navigation module is configured to plan an optimal path according to vehicle distribution and the parking space state information in the lot, so as to navigate vehicles into the parking spaces;
the two-flywheel steering device is mounted at a maximum diameter of a steering wheel, a two-flywheel device comprises a gyro sensor, the moment of inertia of two flywheels and a speed difference between the two flywheels enable the steering wheel to rotate in a designated direction and at a designated angle, and a deflection angle of the steering wheel is calculated according to a height difference between the two flywheels, an angle between a plane where the steering wheel is located and a horizontal plane, and a diameter of the steering wheel;
the mechanical power device comprises a first motor and a second motor, the first motor is configured to control lifting up or pressing down an accelerator pedal, and the second motor is configured to control lifting up or pressing down a brake pedal;
the classification processing module classifies the acquired vehicle information into three categories, which are a manual driving vehicle, a semi-autonomous driving vehicle, and a full-autonomous driving vehicle respectively;
the manual driving vehicle comprises a QR code, a mechanical power device, and a two-flywheel steering device mounted onto the roof of the vehicle, and automatic parking of the manual driving vehicle is achieved by turning the steering wheel through the moment of inertia of the two flywheels and coordinated control of the two flywheels;
the semi-autonomous driving vehicle comprises an autonomous driving power device and a control device, and a QR code mounted onto the roof of the vehicle, so as to achieve communication of position information and environmental information between the parking lot and the vehicle, and an automatic parking function is achieved by using a semi-autonomous driving apparatus of the vehicle; and
the full-autonomous driving vehicle comprises complete power and control devices, and a sensor capable of identifying an environment, the parking lot establishes communication with the full-autonomous driving vehicle, and an automatic parking function is achieved by sending path planning, parking space state information, and vehicle distribution information to the vehicle.

2. The environment active sensing-type automatic parking system in a parking lot according to claim 1, wherein the vehicle information acquired by the vehicle information acquisition and identification module comprises: vehicle entry time, license plate number, and other information, a unique ID is assigned to each of the vehicles according to the license plate number, and the cameras in the vehicle information acquisition and identification module are capable of acquiring and identifying information of the vehicle in every corner of the parking lot without dead angles.

3. The environment active sensing-type automatic parking system in a parking lot according to claim 1, wherein in the vehicle information acquisition and identification module, a polarized light receiver is further mounted around the vehicle to replace the QR code on the roof of the vehicle.

4. The environment active sensing-type automatic parking system in a parking lot according to claim 1, wherein the system further comprises WIFi, Bluetooth, and ZigBee communication devices for auxiliary positioning.

5. The environment active sensing-type automatic parking system in a parking lot according to claim 1, wherein the multi-sensor positioning module is a binocular camera, and calculation formulas of a real coordinate value of a vehicle position are as follows:
$$d = \vert xl - xr \vert$$
$$x = \frac{B \cdot xl}{d}$$
$$y = \frac{B \cdot yt}{d} \\ z = \frac{f \cdot B}{d}$$
wherein f is a camera focal length, coordinates of left and right cameras are (xl, yl) and (xr, yr) respectively, the two cameras have the same height, and thus yl=yr=yt, B is a baseline distance between the two cameras, and d is an absolute value of an x-axis difference between the left and right cameras.

6. The environment active sensing-type automatic parking system in a parking lot according to claim 1, wherein the multi-sensor positioning module is a multi-view camera, the QR code on the vehicle is captured by multiple cameras, and a real coordinate value of the vehicle is obtained by making adjustment calculation by using a multi-sensor fusion method.

7. The environment active sensing-type automatic parking system in a parking lot according to claim 1, wherein the path planning and navigation module calculates vehicle density on each route, and then calculates an optimal path of a to-be-parked vehicle in combination with a breadth first algorithm; generates a corresponding control algorithm according to optimal path information of each vehicle, and then sends a control instruction to the two-flywheel steering device and the mechanical power device in the vehicle through remote communication to navigate the vehicle.

8. The environment active sensing-type automatic parking system in a parking lot according to claim 1, wherein the system further comprises a feedback self-correction module, which is configured to position a vehicle by identifying the QR code on the roof of the vehicle when the vehicle deviates from an originally planned path, calculate an error between the position and a correct position, and then correct the position and attitude of the vehicle through a PID feedback control algorithm.

9. The environment active sensing-type automatic parking system in a parking lot according to claim 1, wherein the mechanical power device is configured to control movement and stop of the vehicle, and feed back vehicle speed and direction signals to a feedback self-correction module.

10. The environment active sensing-type automatic parking system in a parking lot according to claim 1, wherein the gyro sensor in the two-flywheel steering device calculates a height difference h between the two flywheels, a projection of the height difference between the two flywheels onto the plane where the steering wheel is located is recorded as h′, the angle between the plane where the steering wheel is located and the horizontal plane is recorded as α, and the diameter of the steering wheel is recorded as L; then the deflection angle θ of the steering wheel is calculated based on the following calculation formulas:
$${h}^{′} = h \text{/} sin α$$
$$θ = arctan \frac{2 {h}^{′}}{L} .$$
